(19) United States
(12) Patent Application Publication
(10) Pub. No.: US 2023/0315437 A1
(43) Pub. Date: Oct. 5, 2023

(54) SYSTEMS AND METHODS FOR PERFORMING POWER SUPPY UNIT (PSU) FIRMWARE UPDATES WITHOUT INTERRUPTING A USER'S DATAPATH

(71) Applicant: Dell Products, L.P., Round Rock, TX (US)

(72) Inventors: Suren Kumar, Bangalore (IN); Venkatesan K, Puducherry (IN); Latchumi Achudakumar, Chennai (IN); Akbar Sheriff, Salem (IN)

(73) Assignee: Dell Products, L.P., Round Rock, TX (US)

(21) Appl. No.: 17/657,719

(22) Filed: Apr. 1, 2022

(51) Int. Cl. G06F 8/656

(52) U.S. Cl. CPC G06F 8/656

(57) ABSTRACT

Embodiments of systems and methods for performing Power Supply Unit (PSU) firmware updates without interrupting a user's datapath are described. In an illustrative, non-limiting embodiment, an Information Handling System (IHS) may include a processor and a memory coupled to the processor, the memory having program instructions stored thereon that, upon execution by the processor, cause the IHS to: cluster a first set of PSUs into a first logical group and a second set of PSUs into a second logical group, update a first PSU of the first logical group with a firmware image, after the update, assign the first PSU to the second logical group, assign a second PSU of the second logical group to the first logical group, and update the second PSU with the firmware image.

### FIELD

This disclosure relates generally to Information Handling Systems (IHSs), and more specifically, to systems and methods for performing Power Supply Unit (PSU) firmware updates without interrupting a user's datapath.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

A Power Supply Unit (PSU) is an internal IHS hardware component that converts alternating high-voltage current (AC) (e.g., from an electrical outlet) into direct current (DC) and regulates its DC output voltage to the required specifications to provide electrical power to the IHS. Certain types of IHSs (e.g., servers in a chassis) may be equipped with two or more PSUs. In a redundant system, a PSU is switched on while another PSU stands by as a fallback PSU. The fallback PSU is switched on in case of emergency, to avoid IHS downtime. Additionally, or alternatively, two or more PSUs may be switched on at the same time and share the workload.

A PSU controller is a logic device (e.g., microcontroller) that controls the operation of a PSU. As the inventors hereof have recognized, in a multi-PSU IHS, updates to firmware executed by each PSU controller ordinarily require that all PSUs be turned off at the same time, which in turn translates into IHS downtime.

### SUMMARY

Embodiments of systems and methods for performing Power Supply Unit (PSU) firmware updates without interrupting a user's datapath are described. In an illustrative, non-limiting embodiment, an Information Handling System (IHS) may include: a processor and a memory coupled to the processor, the memory having program instructions stored thereon that, upon execution by the processor, cause the IHS to: cluster a first set of PSUs into a first logical group and a second set of PSUs into a second logical group, update a first PSU of the first logical group with a firmware image, after the update, assign the first PSU to the second logical group, assign a second PSU of the second logical group to the first logical group, and update the second PSU with the firmware image.

The IHS may be part of a chassis hosting a plurality of IHSs, and the PSUs may be coupled to the chassis. The processor may include a Chassis Management Controller (CMC). The chassis may include a member chassis, and the program instructions, upon execution, may cause the IHS to receive the firmware image from a lead chassis. To cluster the first and second sets of PSUs into the first and second logical groups, the program instructions, upon execution, may cause the IHS to identify a PSU redundancy configuration. Additionally, or alternatively, to cluster the first and second sets of PSUs into the first and second logical groups, the program instructions, upon execution, may cause the IHS to identify one or more of: a power attribute of each of the PSUs, or a power budget or allocation of each of the PSUs.

The program instructions, upon execution, may cause the IHS to, prior to the update of the first PSU, reduce a volume of communications to or from a CMC. To reduce the communications, the program instructions, upon execution, may cause the IHS to place at least one of: an execution service, a web service, a database service, an inventory service, or a component update service in a halted state. Additionally, or alternatively, to reduce the communications, the program instructions, upon execution, may cause the IHS to re-schedule one or more scheduled tasks to a time after the update of the second PSU. Additionally, or alternatively, to reduce the communications, the program instructions, upon execution, may cause the IHS to wait for one or more running tasks to complete.

The program instructions, upon execution, may cause the IHS to, prior to the update of the first PSU, restore the volume of the communications to or from the CMC. The program instructions, upon execution, may also cause the IHS to roll back the update of the first PSU to a previous firmware version in response to an update failure indication.

In another illustrative, non-limiting embodiment, a hardware memory device may have program instructions stored thereon that, upon execution by a CMC, cause the CMC to: associate a first set of PSUs with a first logical group and a second set of PSUs with a second logical group based, at least in part, upon a PSU redundancy configuration, update a first PSU of the first logical group with a firmware image, after the update, assign the first PSU to the second logical group, assign a second PSU of the second logical group to the first logical group, and update the second PSU with the firmware image.

The program instructions, upon execution, may cause the CMC to, during the update of the first PSU, reduce communications between the CMC and the first and second sets of PSUs. To reduce the communications, the program instructions, upon execution, may cause the CMC to move one or more scheduled tasks to a time outside a PSU update window. The program instructions, upon execution, may also cause the CMC to, prior to the update of the first PSU, increase communications between the CMC and the first and second sets of PSUs.

In yet another illustrative, non-limiting embodiment, a method may include: assembling a first set of PSUs into a first group and a second set of PSUs into a second group, updating a first PSU of the first group with a firmware image, after the update, assigning the first PSU to the second group, assigning a second PSU of the second group to the first group, and updating the second PSU with the firmware image.

The method may include, while updating the first and second PSUs, reducing communications between the CMC and the first and second sets of PSUs. The method may also include, prior to updating the first PSU, moving one or more scheduled tasks to a later time. The method may further include increasing communications between the CMC and the first and second sets of PSUs.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of components of an example Information Handling System (IHS), according to some embodiments.

FIG. 2 is a block diagram of examples of components of a chassis configured with a plurality of IHSs, according to some embodiments.

FIG. 3 is a flowchart of an example of a method for performing Power Supply Unit (PSU) firmware updates without interrupting a user's datapath, according to some embodiments.

FIG. 4 is a flowchart of an example of a method for initiating PSU firmware updates among a plurality of IHSs, according to some embodiments.

FIG. 5 is a flowchart of an example of a method for entering a “No Task Mode” (NTM) of operation, according to some embodiments.

FIG. 6 is a flowchart of an example of a method for clustering PSUs, according to some embodiments.

FIG. 7 is a flowchart of an example of a PSU firmware update rollback method, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

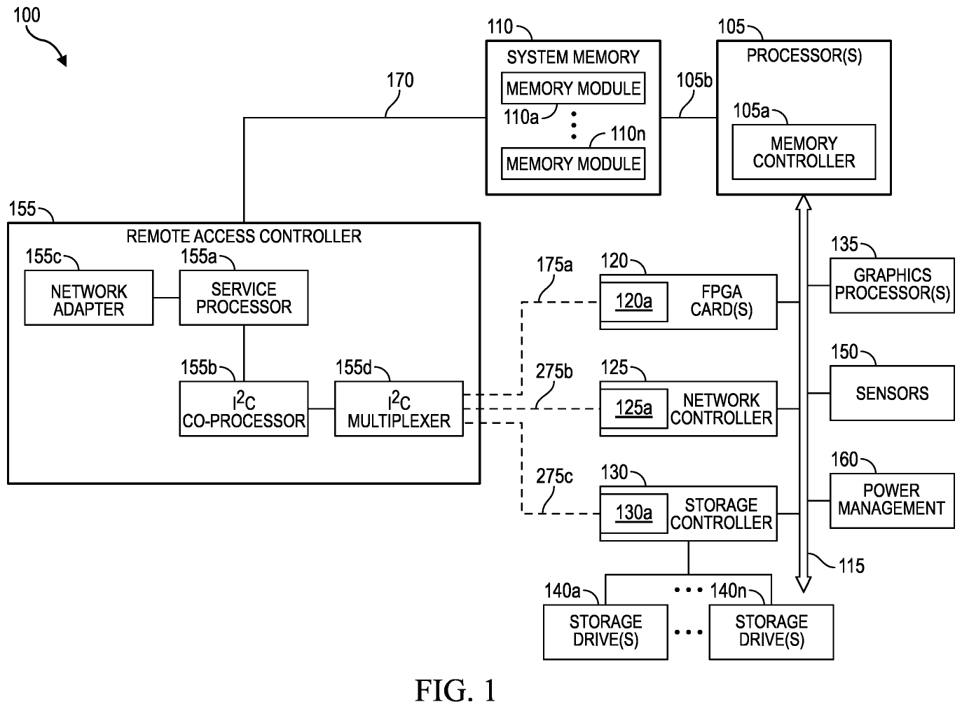

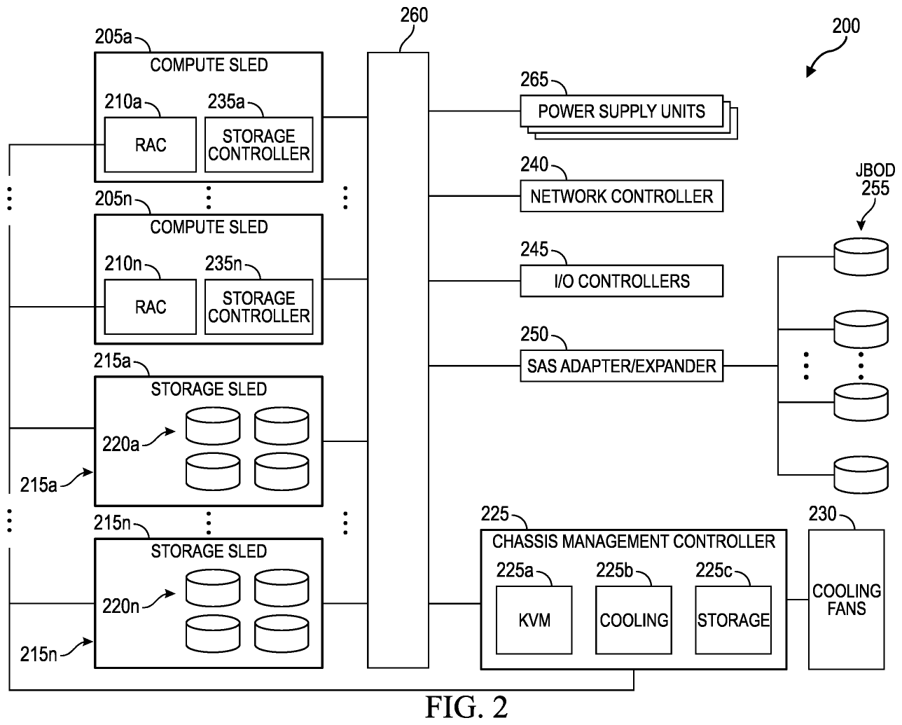

FIG. 1 shows example IHS 100 configured to implement systems and methods for performing Power Supply Unit (PSU) firmware updates without interrupting a user's datapath. For example, IHS 100 may be implemented as any desktop, laptop, or tablet computing device in the form of a client device or IHS. In some cases, IHS 100 may also be a compute sled or server, such as compute sleds 205a-n of FIG. 2, that may be installed within chassis 200 and which may in turn be installed within a rack. Installed in this manner, IHS 100 may utilize shared power, network and cooling resources provided by the chassis and/or rack.

IHS 100 may utilize one or more processor(s) 105. In some embodiments, processor(s) 105 may include a main processor and a co-processor, each of which may include a plurality of processing cores that, in certain scenarios, may each be used to run an instance of a server process. Also, one or more of processor(s) 105 may be graphics processing units (GPUs), for example, in scenarios where IHS 100 has been configured to support functions such as multimedia services and graphics applications.

As illustrated, processor(s) 105 include integrated memory controller 105a that may be implemented directly within the circuitry of processor 105. Alternatively, memory controller 105a may be a separate Integrated Circuit (IC) that is located on the same die as processor 105. Memory controller 105a may be configured to manage the transfer of data to and from system memory 110 via a high-speed memory interface 105b.

System memory 110 is coupled to processor(s) 105 via memory bus 105b. System memory 110 may be used to store computer program instructions and data executed by the processor(s) 105. Accordingly, system memory 110 may include memory components such as such as static RAM (SRAM), dynamic RAM (DRAM), NAND Flash memory, etc., or other components suitable for supporting high-speed memory operations by the processor(s) 105. In certain embodiments, system memory 110 may combine non-volatile and volatile memories.

In certain embodiments, system memory 110 may include multiple removable memory modules 110a-n. Each of removable memory modules 110a-n may correspond to a Printed Circuit Board (PCB) memory socket that receives removable memory module 110a-n, such as a DIMM (Dual In-line Memory Module), that can be coupled to the socket and then decoupled from the socket as needed, such as to upgrade memory capabilities or to replace faulty components. Other implementations of system memory 110 may be configured with one or more socket interfaces for memory modules having other form factors, such as a Dual In-line Package (DIP) memory, a Single In-line Pin Package (SIPP) memory, a Single In-line Memory Module (SIMM), and/or a Ball Grid Array (BGA) memory.

IHS 100 may utilize a chipset implemented by IC(s) that are connected to each of processor(s) 105. Alternatively, all or portions of a chipset may be implemented directly within the IC of individual processor(s) 105. The chipset may provide the processor(s) 105 with access to a variety of resources accessible via one or more buses 115. Various embodiments may utilize any number of buses to provide the illustrated pathways served by bus 115. For example, bus 115 may include a PCIe (PCI Express) switch fabric accessed via a PCIe root complex.

IHS 100 may also include one or more sensors 150. In various implementations, sensors 150 may include, but are not limited to: electric, magnetic, hall effect, radio, optical, infrared, thermal, force, pressure, touch, acoustic, ultrasonic, proximity, position, location, angle (e.g., hinge angle), deformation, bending, direction, movement, velocity, rotation, acceleration, bag state (in or out of a bag), and/or lid sensor(s) (open or closed). One or more of sensors 150 may be disposed within IHS 100, on a bezel of IHS 100, on a display, on a hinge coupling a display portion to a keyboard portion of IHS 100, or on a keyboard or other input device.

For example, processor(s) 105 may process user presence data received by sensors 150 and may determine, for example, whether an end-user is present or absent. Moreover, in situations where the end-user is present before IHS 100, processor(s) 105 may further determine a distance of the end-user from IHS 100 continuously or at pre-determined time intervals. The detected or calculated distances may be used by processor(s) 105 to classify the user as being in the IHS's near-field (user's position<threshold distance A), mid-field (threshold distance A<user's position<threshold distance B, where B>A), or far-field (user's position>threshold distance C, where C>B) with respect to IHS 100.

More generally, in various implementations, processor(s) 105 may receive and/or to produce system context information using sensors 150 including one or more of, for example: a user's presence state (e.g., present, near-field, mid-field, far-field, absent), a facial expression of the user, a direction of the user's gaze, a user's gesture, a user's voice, an IHS location (e.g., based on the location of a wireless access point or Global Positioning System), IHS movement (e.g., from an accelerometer or gyroscopic sensor), lid state (e.g., of a laptop), hinge angle (e.g., in degrees), IHS posture (e.g., laptop, tablet, book, tent, and display), whether the IHS is coupled to a dock or docking station, a distance between the user and at least one of: the IHS, the keyboard, or a display coupled to the IHS, a type of keyboard (e.g., a physical keyboard integrated into IHS 100, a physical keyboard external to IHS 100, or an on-screen keyboard), whether the user operating the keyboard is typing with one or two hands (e.g., holding a stylus, or the like), a time of day, software application(s) under execution in focus for receiving keyboard input, whether IHS 100 is inside or outside of a carrying bag, ambient lighting, a battery charge level, whether IHS 100 is operating from battery power or is plugged into an AC power source (e.g., whether the IHS is operating in AC-only mode, DC-only mode, or AC+DC mode), a power consumption of various components of IHS 100.

As illustrated, a variety of resources may be coupled to processor(s) 105 via bus 115. For instance, processor(s) 105 may be coupled to network controller 125, such as provided by a Network Interface Controller (NIC) that allows IHS 100 to communicate via an external network, such as the Internet or a LAN. Power management and cooling unit 160 may include a plurality of PSUs, fans, and/or liquid cooling devices coupled to processor(s) 105 via bus 115. When IHS 100 is implemented as a blade or sled in a chassis, processor(s) 105 may also be coupled to power management unit and cooling unit 160 to interface with the chassis' power and/or cooling systems (e.g., components 230 and 265 in FIG. 2).

In certain embodiments, graphics processor 135 may be included within one or more video or graphics cards, or an embedded controller, installed as components of IHS 100. Additionally, or alternatively, graphics processor 135 may be integrated into Remote Access Controller (RAC) 155 and may be utilized to support the display of diagnostic and administrative interfaces related to IHS 100 via display devices that are coupled, either directly or remotely, to RAC 155.

As illustrated, IHS 100 may include one or more FPGA (Field-Programmable Gate Array) card(s) 120. Each FPGA card 120 supported by IHS 100 may include various processing and memory resources that may be reconfigured after deployment of IHS 100 through programming functions supported by the FPGA card 120. Each individual FGPA card 120 may be optimized to perform specific processing tasks, such as specific signal processing, security, data mining, and AI/ML functions, and/or to support specific hardware coupled to IHS 100.

IHS 100 may also support storage controller 130 to provide access to virtual storage configurations. For instance, storage controller 130 may provide support for RAID (Redundant Array of Independent Disks) configurations of storage devices 140a-n (e.g., as provided by storage sleds 215a-n and JBOD 255 of FIG. 2). In some embodiments, storage controller 130 may be a Host Bus Adapter (HBA).

In certain embodiments, IHS 100 may operate using a BIOS (Basic Input/Output System) that may be stored in a non-volatile memory accessible by processor(s) 105. The BIOS may provide an abstraction layer by which the Operating System (OS) of IHS 100 interfaces with hardware components. Upon powering or restarting IHS 100, processor(s) 105 may utilize BIOS instructions to initialize and test hardware components coupled to the IHS, including components permanently installed on the motherboard of IHS 100 and removable components installed in expansion slots supported by the IHS 100. The BIOS instructions may also load an OS for use by the IHS 100. In certain embodiments, IHS 100 may utilize Unified Extensible Firmware Interface (UEFI) in addition to or instead of a BIOS. Certain operations provided by a BIOS may be implemented, in full or in part, by RAC 155.

RAC 155 may operate from a different power plane from processor(s) 105 and other components of IHS 100, thus allowing RAC 155 to operate, and management tasks to proceed, while the processing cores of processor(s) 105 are powered off. In some embodiments, RAC 155 may perform various operations to verify the integrity of IHS 100 and its hardware components prior to initialization (i.e., in a bare-metal state). In other embodiments, RAC 155 may implement aspects of systems and methods for performing PSU firmware updates without interrupting a user's datapath, as described herein.

RAC 155 may include service processor 155a, or a specialized microcontroller, that operates management software that supports remote monitoring and administration of IHS 100. RAC 155 may be installed on the motherboard of IHS 100 or may be coupled to IHS 100 via an expansion slot provided by the motherboard. In support of remote monitoring, network adapter 125c may provide connections to RAC 155 using wired and/or wireless network connections via a variety of network technologies. As a non-limiting example of a RAC, the integrated Dell Remote Access Controller (iDRAC) from Dell® is embedded within Dell PowerEdge™ servers and provides functionality that helps information technology (IT) administrators deploy, update, monitor, and maintain servers remotely.

In some embodiments, RAC 155 may support monitoring and administration of various devices 120, 125, 130 of IHS 100 via a sideband interface. In such embodiments, the messages in support of monitoring and management may be implemented using MCTP (Management Component Transport Protocol) transmitted using I²C sideband bus connection 175a-c established with each of the respective managed devices 120, 125, 130. As illustrated, the managed hardware components of the IHS 100, such as FPGA cards 120, network controller 125, and storage controller 130, are coupled to processor(s) 105 via in-line bus 115, such as a PCIe root complex, that is separate from I²C sideband bus connection 175a-c.

In certain embodiments, service processor 155a may use I²C co-processor 155b to implement sideband I²C communications between RAC 155 and managed components 120, 125, 130. I²C co-processor 155b may be a specialized co-processor or micro-controller that is configured to interface via a sideband I²C bus interface with the managed hardware components 120, 125, 130 of IHS. In some embodiments, I²C co-processor 155b may be integrated into service processor 155a, as a peripheral system-on-chip (SoC) feature provided by service processor 155a. Each I²C bus 175a-c is illustrated as single line; however, each I²C bus 175a-c may include a clock line and data line that couple RAC 155 to I²C endpoints 120a, 125a, 130a, which may be referred to as field replaceable units (FRUs).

I²C co-processor 155b may interface with individual managed devices 120, 125 and 130 via sideband I²C buses 175a-c selected through the operation of I²C multiplexer 155d. In response to switching operations by I²C multiplexer 155d, sideband bus connection 175a-c may be established by a direct coupling between I²C co-processor 155b and each individual managed device 120, 125, or 130.

In providing sideband management capabilities, I²C co-processor 155b may each interoperate with corresponding endpoint I²C controllers 120a, 125a, 130a that implement the I²C communications of the respective managed devices 120, 125, and 130. Endpoint I²C controllers 120a, 125a, 130a may be implemented as a dedicated microcontroller for communicating sideband I²C messages with RAC 155. Alternatively, endpoint I²C controllers 120a, 125a, 130a may be implemented as integrated SoC functions of a processor of the respective managed device endpoints 120, 125, and 130.

As described, IHS 100 may be used to implement compute sleds 205a-n and/or storage sleds 215a-n of chassis 200 shown in FIG. 2. Accordingly, IHS 100 may be included within a large system of similarly configured IHSs that may be housed within the same chassis, rack, and/or datacenter. In those scenarios, each RAC 155 may be configured to support automated deployment of IHS 100's OSs according to configuration settings specified by an administrator.

FIG. 2 is a block diagram illustrating certain components of chassis 200 comprising one or more compute sleds 205a-n and one or more storage sleds 215a-n configured to implement systems and methods for performing PSU firmware updates without interrupting a user's datapath. Chassis 200 may include one or more bays, and each bay receives an individual sled (that may be additionally or alternatively referred to as a tray, blade, and/or node), such as compute sleds 205a-n and storage sleds 215a-n. Chassis 200 may support different numbers (e.g., 4, 8, 12, 24), sizes (e.g., single-width, double-width) and physical configurations of bays.

Other embodiments may include additional types of sleds that provide various types of storage and/or processing capabilities. Other types of sleds may provide power management and networking. Sleds may be individually installed and removed from chassis 200, thus allowing the computing and storage capabilities of chassis 200 to be reconfigured by swapping the sleds with different types of sleds, in many cases without affecting the operations of the other sleds.

Multiple chassis 200 may be housed within a rack. Data centers may utilize large numbers of racks, with different types of chassis installed in various configurations of racks. The modular architecture provided by the sleds, chassis, and racks allow for certain resources, such as cooling, power, and network bandwidth, to be shared among compute sleds 205a-n and storage sleds 215a-n, thus providing efficiency improvements and supporting greater computational loads.

Chassis 200 may be installed within a rack structure that provides all or part of the cooling utilized by chassis 200. For airflow cooling, a rack may include one or more banks of cooling fans that may be operated to ventilate heated air from within chassis 200 housed within the rack. Chassis 200 may alternatively or additionally include one or more cooling fans 230 that may be similarly operated to ventilate heated air from within sleds 205a-n, 215a-n installed within chassis 200. A rack and chassis 200 installed within the rack may utilize various configurations and combinations of cooling fans to cool sleds 205a-n, 215a-n and other components housed within chassis 200.

Sleds 205a-n, 215a-n may be individually coupled to chassis 200 via connectors that correspond to the bays provided by chassis 200 that physically and electrically couple an individual sled to backplane 260. Chassis backplane 260 may be a printed circuit board that includes electrical traces and connectors configured to route signals between the various components of chassis 200 connected to backplane 260. In various embodiments, backplane 260 may include various additional components, such as cables, wires, midplanes, backplanes, connectors, expansion slots, and multiplexers. In certain embodiments, backplane 260 may be a motherboard that includes various electronic components installed thereon. Such components installed on motherboard backplane 260 may implement all or part of the operations described with regard to Serial Attached SCSI (SAS) expander 250, I/O controllers 245, network controller 240, and PSUs 265.

In certain embodiments, one or more of compute sleds 205a-n may be implemented as IHS 100 of FIG. 1. Compute sleds 205a-n may provide computational processing resources that may be used to support a variety of e-commerce, multimedia, business and scientific computing applications, such as services provided via a cloud implementation. Compute sleds 205a-n are typically configured with hardware and software that provide leading-edge computational capabilities. Accordingly, services provided using such computing capabilities are typically provided as high-availability systems that operate with minimum downtime. Compute sleds 205a-n may be configured for general-purpose computing or may be optimized for specific computing tasks.

Each compute sled 205a-n includes a respective one of RACs 210a-n. RACs 210a-n provide capabilities for remote monitoring and management of compute sled 205a-n. In support of these monitoring and management functions, RACs 210a-n may utilize both in-band and sideband (i.e., out-of-band) communications with various components of a compute sled 205a-n and chassis 200. RACs 210a-n may collect sensor data, such as temperature sensor readings, from components of chassis 200 in support of airflow cooling of chassis 200 and sleds 205a-n, 215a-n. In addition, each of RACs 210a-n may implement various monitoring and administrative functions related to compute sleds 205a-n that require sideband bus connections with various internal components of the respective compute sleds 205a-n.

As illustrated, chassis 200 includes one or more storage sleds 215a-n that are coupled to the backplane 260 and installed within one or more bays of chassis 100 in a similar manner to compute sleds 205a-n. Each of the individual storage sleds 215a-n may include different numbers and types of storage devices. For instance, storage sleds 215a-n may include SAS magnetic disk drives, Serial Advanced Technology Attachment (SATA) magnetic disk drives, solid-state drives (SSDs), and other types of storage drives in any combination. Storage sleds 215a-n may be utilized in various storage configurations by compute sleds 205a-n.

Each of compute sleds 205a-n includes a respective one of storage controllers 235a-n that may be utilized to access storage drives accessible via chassis 200. Some of storage controllers 235a-n may provide support for Redundant Array of Independent Disks (RAID) configurations of logical and physical storage drives, such as storage drives provided by storage sleds 215a-n. In some embodiments, some or all storage controllers 235a-n may be Host Bus Adapters (HBAs) that provide more limited capabilities in accessing physical storage drives provided via storage sleds 215a-n and/or via SAS expander 250.

In addition to the data storage capabilities provided by storage sleds 215a-n, chassis 200 may provide access to other storage resources that may be installed components of chassis 200 and/or may be installed elsewhere within a rack housing chassis 200, such as within a storage blade. In certain scenarios, storage resources 255 may be accessed via SAS expander 250 coupled to backplane 260 of chassis 200. SAS expander 250 may support connections to a number of Just a Bunch Of Disks (JBOD) storage drives 255 that may be configured and managed individually and without implementing data redundancy across drives 255. Additional storage resources 255 may also be at various other locations within a datacenter in which chassis 200 is installed. Additionally, or alternatively, storage resources 255 may be remotely located.

Chassis 200 includes network controller 240 that provides network access to sleds 205a-n, 215a-n. Network controller 240 may include various switches, adapters, controllers, and couplings used to connect chassis 200 to a network, either directly or via additional networking components and connections provided via a rack in which chassis 200 is installed. Chassis 200 may similarly include PSUs 265 that provide the components of chassis 200 with various levels of DC power from an AC power source or from power delivered via a power system provided by a rack within which chassis 200 may be installed. In some cases, PSUs 265 may be implemented within a sled that provides chassis 200 with redundant, hot-swappable power supplies.

Each of PSUs 265 may include a microcontroller (a “PSU controller”) configured to operate aspects of its hardware based, at least in part, upon the execution of firmware instructions stored in a memory (e.g., EPROM, flash, etc.). The term “PSU firmware,” as used herein, refers to a class of software that provides low-level control for a PSU's hardware. In various implementations, PSU firmware may be subject to updates, revisions, or upgrades (collectively referred to as “updates”). A PSU firmware update may contain up-to-date or advanced operational instructions that provide new or enhanced features and/or that improve the PSU's operation, without changes in the PSU's hardware.

Chassis 200 may also include various I/O controllers 240 that may support various I/O ports, such as USB ports that may be used to support keyboard and mouse inputs and/or video display capabilities. I/O controllers 245 may be utilized by Chassis Management Controller (CMC) 225 to support various KVM (Keyboard, Video, and Mouse) 225a capabilities that provide administrators with the ability to interface with chassis 200.

Airflow cooling 230 may include an airflow cooling system that is provided by a rack in which chassis 200 may be installed and managed by cooling module 225b of CMC 225. In addition to providing support for KVM 225a capabilities for administering chassis 200, CMC 225 may support various additional functions for sharing the infrastructure resources of chassis 200. In some scenarios, CMC 225 may implement tools for managing PSUs 265, network bandwidth 240, and airflow cooling 230 available in chassis 200.

Particularly, CMC 225 may include program instructions that, upon execution, instantiates chassis management software that enables comprehensive management of various components with chassis 200 from a single web or Application Programming Interface (API) interface console. An example of such software executable by CMC 225 is OPENMANAGE ENTERPRISE available from DELL TECHNOLOGIES INC. As such, CMC 225 may simplify lifecycle administration to help scale and support a secure infrastructure with validated software bundles and secure firmware updates that reduce risks for business-critical operations, as well as remote management integration with RACs 210a-n,

In the illustrated embodiment, chassis management controller 225 includes storage module 225c that provides capabilities for managing and configuring certain aspects of the storage devices of chassis 200, such as the storage devices provided within storage sleds 215a-n and within JBOD 255. Each of storage controllers 235a-n may be used to implement various types of virtual storage configurations, such as RAID configurations, using the storage devices provided by chassis 200. Accordingly, chassis 200 may support large numbers of combinations of different storage devices that may be configured in various types of storage profiles.

In some embodiments, CMC 225 may further implement aspects of systems and methods for performing PSU firmware updates without interrupting a user's datapath, as described herein.

Storage module 225c of the chassis management controller 225 may support requests for storage configurations by each of storage controllers 235a-n by selecting and mapping storage devices from those available within chassis 200, and in certain embodiments, from those available in any other similarly configured chassis that can be accessed by CMC 225.

Storage module 225c may also be further configured to manage all unmapped storage devices of chassis 200 as a global pool of spare storage devices that may be used to support the storage configurations operated by each of storage controllers 235a-n. In this manner, the capabilities of the chassis management controller 225 may provide administrators with the ability to set up virtual storage configurations using all shared storage resources that are available within chassis 200, or within other accessible chassis.

In other embodiments, IHS 100 and chassis 200 may not include all the components shown in FIGS. 1 and 2. In other embodiments, IHS 100 and chassis 200 may include other components in addition to those that are shown in FIGS. 1 and 2. Furthermore, some components that are represented as separate components in FIGS. 1 and 2 may instead be integrated with other components. For example, all or a portion of the operations executed by the illustrated components may instead be provided by components integrated into one or more processor(s) as an SoC or the like. For example, IHS 100 may be implemented as different classes of computing devices including, but not limited to: servers, workstations, desktops, laptops, appliances, video game consoles, tablets, smartphones, etc.

In a conventional modular chassis, to update the firmware of PSUs 265 (e.g., using a management console such as OPEN MANAGE ENTERPRISE MODULAR from Dell®), all the components connected in the chassis (e.g., blade servers, storage, I/O devices, and chassis) would need to be turned off, in contrast with other components' firmware updates which do not require application and/or workload (referred to as a “user datapath”) downtime. In large sever rooms and datacenters, performing the PSU firmware updates can be challenging and time consuming.

For example, consider the case of 20 chassis, each chassis with 6 PSUs, for a total of 120 PSUs. To update the PSU firmware, the user may perform all 120 PSU firmware updates in a single instance—but this approach is typically impractical because it requires powering off all the 20 chassis at the same time (for approximately 60 minutes), which is likely to have a high business impact. Alternatively, a user may power off one chassis at a time and initiate twenty iterations of the PSU firmware update job for each chassis in a sequential manner—but this approach is time consuming and requires significant manual intervention. For example, if updating 6 PSUs in single chassis took 40 minutes, all 20 chassis (i.e., 120 PSUs) would take approximately 13 hours.

As the inventors hereof have recognized, chassis 200 is powered off during a PSU firmware update to prevent any internal communication breaks between CMC 225 and PSUs 265 during the update process. If chassis 200 were powered on during a PSU firmware update, regular operation of the chassis would cause interruptions and lead to failures.

To address these, and other issues, systems and methods described herein may provide end-to-end automated intelligence to perform clustered-based modular chassis PSU firmware updates without downtime (e.g., applications and/or workload) of any IHS (e.g., blade server) in the chassis—that is, without interrupting the user's datapath. Depending on the PSU availability and redundancy configuration, these systems and methods may identify one or two PSUs and make them offline to perform the PSU firmware update. All PSUs in a chassis may get updated using a cluster-based, PSU firmware update approach.

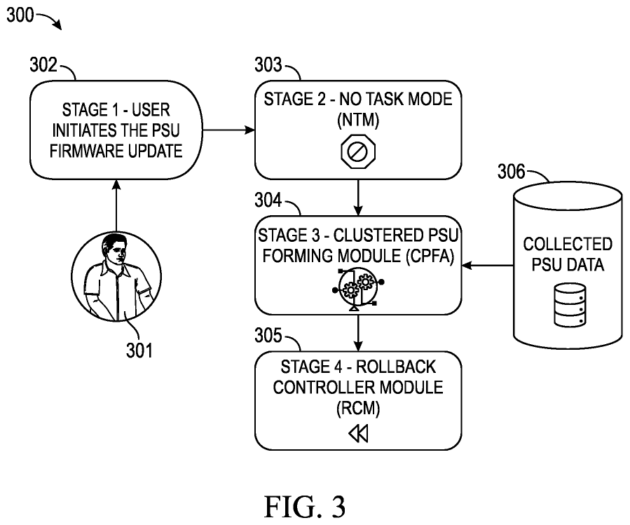

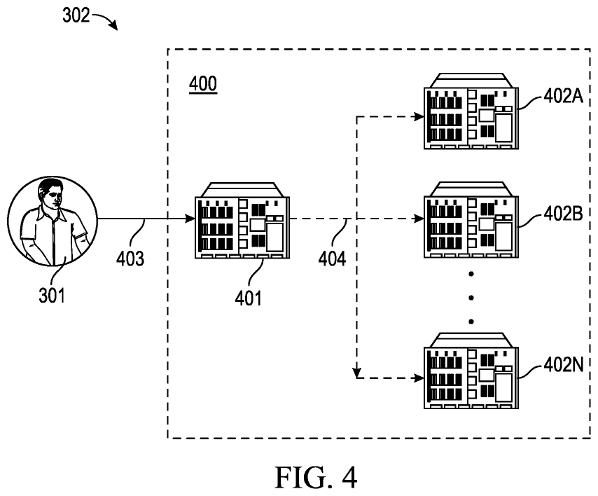

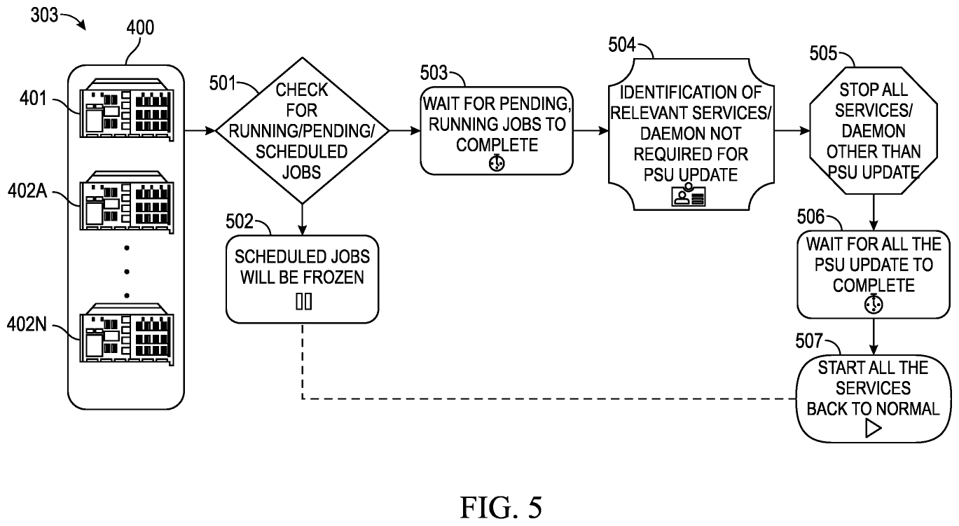

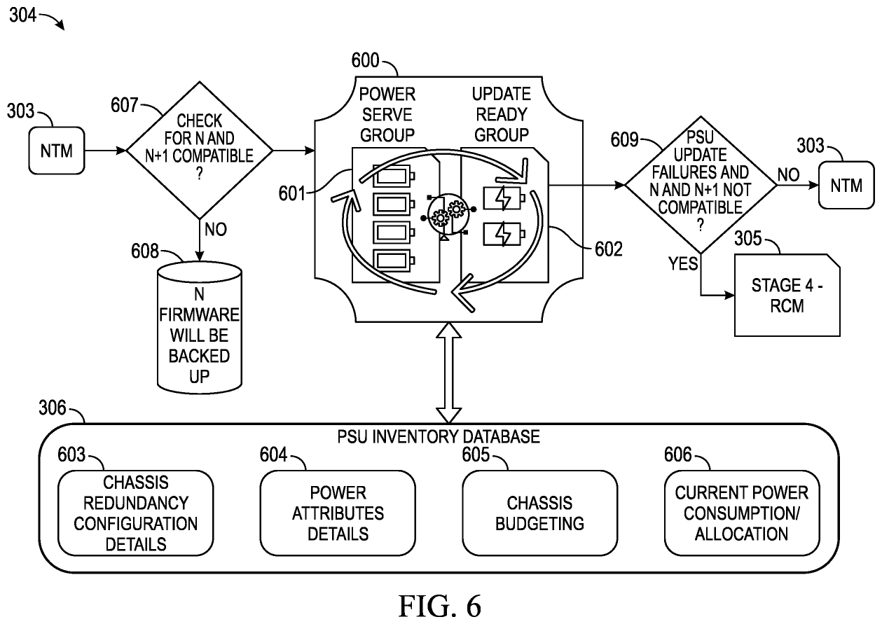

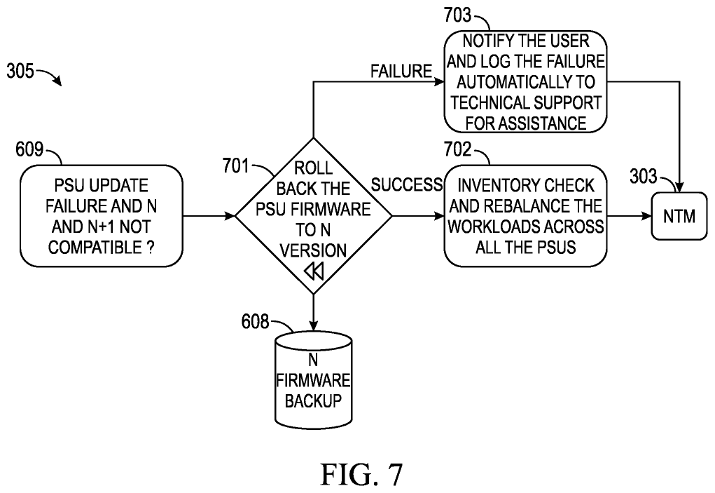

FIG. 3 is a flowchart of an example of method 300 for performing PSU firmware updates without interrupting a user's datapath. At 302, method 301 enters “stage 1” and initiates a PSU firmware update process, for example, at the request of user 301, as described in more detail in connection with FIG. 4. At 303, method 302 enters “stage 2” and places a chassis in a “No Task Mode” (NTM) of operation, as described in more detail in connection with FIG. 5. At 304, method 302 enters “stage 3” and triggers the operation of a clustered PSU forming module (CPFA) based, at least in part, upon collected PSU data 306, as described in more detail in connection with FIG. 6. Then, at 305, method 302 enters “stage 4” and initiates the operation of a rollback controller module (RCM), as described in more detail in connection with FIG. 7.

Particularly, FIG. 4 is a flowchart of an example of a method for initiating PSU firmware updates among a plurality of IHSs, which corresponds to block 302 of method 300 in FIG. 3. In some implementations, chassis 401 may be designated as a lead chassis, and the remaining chassis 402A-N in communication therewith may be designated as member chassis. To update the PSU firmware in a selected chassis, user 301 may be provided interface 403, such as a Graphical User Interface (GUI) and/or a REST interface.

Lead chassis 401 may receive, retrieve, or download an update package that includes a PSU firmware update, for example, from a remote service. Lead chassis 401 may then perform a signature check of the update package or PSU firmware update extracted therefrom. Lead chassis 401 may also perform a compliance check of the update package or PSU firmware update to identify PSUs that are compatible with the PSU firmware update (e.g., by model number, etc.). Then, at 403, lead chassis 401 may transfer the PSU firmware update (e.g., a binary file) to each CNC 225 of member chassis 402A-N.

FIG. 5 is a flowchart of an example of a method where each member chassis 402A-N enters an NTM mode of operation once the PSU firmware update image is received and PSU update jobs are created, which corresponds to block 303 of method 300 in FIG. 3. When a chassis is operating in NTM mode, systems and methods described herein may identify essential services required for smooth PSU firmware updates. These systems and methods may stop all other CMC operations (and their associated daemon services) until the completion of PSU update, thus ensuring no interruptions.

Regular chassis-related activities may be frozen and parked outside the PSU update window. As such, during the PSU update, I²C communication traffic is used only for CMC and PSU communications, and no other traffic is running in the I²C bus. In NTM mode, no configuration related to the chassis is allowed, thus reducing a volume of communications between CMC 225 and other components or services.

At 501, an NTM module executed by CMC 225 may check for pending, running, and/or scheduled tasks, and at 503 it may wait for logical closure on all the pending and running tasks. At 502, scheduled jobs are re-scheduled to a later time outside the expected update window for all PSUs being updated. At 504, one or more task execution services, Tomcat or other web services, database services, inventory services, or component update services for all components installed in the chassis, except for PSUs, are identified by calling the respective daemons associated with such services. At 505, the identified services are halted, stopped, or frozen.

The NTM process may ensure that the identified services are successfully stopped or disabled, and it may check 120 communication to/from CMC 225 to ensure no traffic other than relating to the PSU firmware update process is allowed. The NTM process may also indicate to a CPFM module to start the update workflow, as shown in FIG. 6.

At 506, the NTM process waits for PSU update job(s) to complete. Once the PSU update job(s) is/are completed, control returns to block 507. At 507, the NTM process may start all the daemons associated with the stopped/disabled services and resume operations back to working state, such that all operations are unfrozen. The NTM process may also ensure that 120 traffic flow to/from CMC 225 is normal. Scheduled jobs may then be put under a running state. Moreover, the user may be allowed to perform all configuration operations as usual, without contingencies.

FIG. 6 is a flowchart of an example of a method for clustering PSUs, which corresponds to block 304 of method 300 in FIG. 3. A CPFM module executed by CMC 225 may analyze the chassis' PSU inventory, current Power configurations, power usage of the chassis, blade servers, storage, and I/O devices to: (1) form PSU clusters or logical groups, and (2) perform the PSU firmware updates based on the PSU clusters.

To form PSU clusters 600, the CPFM process may create two logical PSU groups 601 (“power serve group”) and 602 (“update ready group”) which are updated in a sequential manner automatically. Particularly, a selected number of PSUs in group 602 may be updated by bringing them PSU into an offline state, triggering the firmware update job, and performing the update one after the other. The remaining PSUs are in group 601 and provide the essential power requirements for the chassis and its devices. Moreover, these operations may be performed in all chassis in parallel.

The CPFM process may collect PSU inventory for the chassis from PSU inventory database 306. The information contained in the inventory may reflect, the current power consumption and/or allocation for each PSU, the chassis' redundancy configuration, power attributes, chassis budgeting, etc. Based on this data, the two logical groups 601 and 602 may be formed in each chassis.

Table I below denotes examples of different redundancy configurations. The CPFM module may dynamically classify PSUs into groups 601 or 602, at least in part, based upon inventory details.

TABLE I

| Redundancy | PSU | | | |
|---|---|---|---|---|
| Mode | Count | CPFM Operation | Group 601 | Group 602 |
| PSU | 6 | Min. PSU Req: 4 | 4 + 1 | 1 |
| Redundancy | | Redundant: 1 | | |
| Grid | 6 | Min. PSU Req: 3 | 3 (Grid-A) | 3 (Grid-B) |
| Redundancy | | Redundant: 3 | | |
| No | 6 | Min. PSU Req: 4 | 4 | 2 |
| Redundancy | | Redundant: 0 | | |

At 607, the CPFM process may check for N and N+1 PSU firmware compatibility for all the PSUs in the chassis and if the mix of different PSU firmware is compatible. If not, then at 608, before starting the firmware update, the current firmware image may be backed up for rollback operation (i.e., in case of failure).

The PSU firmware binary image is transferred to a selected PSU from group 602 and an update job starts. The CPFM process may monitor the PSU update status for its completion. Once the PSU update is determined to have been successful, the CPFM process may move the updated PSU to group 601. The CPFM process may then re-process the PSUs for another iteration of update. Particularly, the CPFM process may inventory updated PSUs and check the PSU firmware version. The process continues until all the installed PSUs updated in the chassis. These PSU update may be performed in parallel for a plurality of chassis, with a CPFM module instantiated in each individual chassis to control the chassis' PSU update workflow.

At 609, if any PSU update fails, the CPFM process may retry it. If after a selected number of iterations (e.g., 3) the PSU update is still unsuccessful, the PSU inventory may be updated accordingly. Otherwise, at 305, the error and failure may be reported to indicate a compatibility issue with N and N+1 firmware. Once all the PSU updates are completed, the CPFM process may return control to NTM process 303 with the success/failure status.

FIG. 7 is a flowchart of an example of a PSU firmware update rollback method, which corresponds to block 305 of method 300 in FIG. 3. In various embodiments, an RCM module instantiated by CMC 225 may implement this method in case of any PSU update failures and/or for any of the compatibility issues between N and N+1 PSU firmware. As such, the RCM process may receive inputs from the CPFM module, check the failed PSU status, and protect subsequent PSU updates to avoid failures.

Particularly, at 701, the RCM process may perform a firmware rollback operation when N and N+1 PSU firmware are not compatible to work in single chassis, as determined in 609. Specifically, the RCM process may perform a recovery operation by bringing up the PSU to an online state with its initial PSU Firmware (i.e., the N version), which was already backed up by the CPFM process. For instance, assume three PSUs have been updated to their latest firmware version N+1 at 304 and fourth PSU ended up in failure.

In that case, at 701 the RCM process may rollback the PSU firmware for the already updated PSUs to the N firmware version and, if the rollback is successful, the RCM process may rebalance workloads across all PSUs at 702. Still at 702, the RCM process may inventory the updated PSU and check that the updated firmware version is reported correctly.

If the rollback operation of 701 is not successful, at 703 the RCM process may provide appropriate logs/reports to the user on the failures, and the user may be notified to perform the PSU update for that failed chassis. Additionally, or alternatively, the RCM process may log the failure automatically to technical support for assistance. The RCM process may then return control to the NTM module after the rollback and/or rebalancing operations are successfully completed.

As such, systems and methods described herein provide a cluster-based approach to performing end-to-end, automated PSU firmware update for modular chassis without any downtime. These systems and methods may also identify and freeze the modular chassis nonessential services and allow only the PSU firmware update service to run. Furthermore, these systems and methods may automatically reconfigure and rebalance PSU redundancy in case of runtime PSU failure during the firmware update.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor;
a memory coupled to the processor, the memory having program instructions stored thereon that, upon execution, cause the IHS to:
cluster a first set of Power Supply Units (PSUs) into a first logical group and a second set of PSUs into a second logical group;
update a first PSU of the first logical group with a firmware image;
after the update, assign the first PSU to the second logical group;
assign a second PSU of the second logical group to the first logical group; and
update the second PSU with the firmware image.

2. The IHS of claim 1, wherein the IHS is part of a chassis hosting a plurality of IHSs, and wherein the PSUs are coupled to the chassis.

3. The IHS of claim 2, wherein the processor comprises a Chassis Management Controller (CMC).

4. The IHS of claim 1, wherein the chassis comprises a member chassis, and wherein the program instructions, upon execution, further cause the IHS to receive the firmware image from a lead chassis.

5. The IHS of claim 1, wherein to cluster the first and second sets of PSUs into the first and second logical groups, the program instructions, upon execution, further cause the IHS to identify a PSU redundancy configuration.

6. The IHS of claim 1, wherein to cluster the first and second sets of PSUs into the first and second logical groups, the program instructions, upon execution, further cause the IHS to identify one or more of: a power attribute of each of the PSUs, or a power budget or allocation of each of the PSUs.

7. The IHS of claim 1, wherein the program instructions, upon execution, further cause the IHS to, prior to the update of the first PSU, reduce a volume of communications to or from a Chassis Management Controller (CMC).

8. The IHS of claim 7, wherein to reduce the communications, the program instructions, upon execution, further cause the IHS to place at least one of: an execution service, a web service, a database service, an inventory service, or a component update service in a halted state.

9. The IHS of claim 7, wherein to reduce the communications, the program instructions, upon execution, further cause the IHS to re-schedule one or more scheduled tasks to a time after the update of the second PSU.

10. The IHS of claim 7, wherein to reduce the communications, the program instructions, upon execution, further cause the IHS to wait for one or more running tasks to complete.

11. The IHS of claim 7, wherein the program instructions, upon execution, further cause the IHS to, prior to the update of the first PSU, restore the volume of the communications to or from the CMC.

12. The IHS of claim 1, wherein the program instructions, upon execution, further cause the IHS to roll back the update of the first PSU to a previous firmware version in response to an update failure indication.

13. A hardware memory device having program instructions stored thereon that, upon execution by a Chassis Management Controller (CMC), cause the CMC to:
associate a first set of Power Supply Units (PSUs) with a first logical group and a second set of PSUs with a second logical group based, at least in part, upon a PSU redundancy configuration;
update a first PSU of the first logical group with a firmware image;
after the update, assign the first PSU to the second logical group;
assign a second PSU of the second logical group to the first logical group; and
update the second PSU with the firmware image.

14. The hardware memory device of claim 13, wherein the program instructions, upon execution, further cause the CMC to, during the update of the first PSU, reduce communications between the CMC and the first and second sets of PSUs.

15. The hardware memory device of claim 14, wherein to reduce the communications, the program instructions, upon execution, further cause the CMC to move one or more scheduled tasks to a time outside a PSU update window.

16. The hardware memory device of claim 14, wherein the program instructions, upon execution, further cause the CMC to, prior to the update of the first PSU, increase communications between the CMC and the first and second sets of PSUs.

17. A method, comprising:
assembling a first set of Power Supply Units (PSUs) into a first group and a second set of PSUs into a second group;
updating a first PSU of the first group with a firmware image;
after the update, assigning the first PSU to the second group;
assigning a second PSU of the second group to the first group; and
updating the second PSU with the firmware image.

18. The method of claim 17, further while updating the first and second PSUs, reducing communications between the CMC and the first and second sets of PSUs.

19. The method of claim 18, further comprising, prior to updating the first PSU, moving one or more scheduled tasks to a later time.

20. The method of claim 18, further comprising increasing communications between the CMC and the first and second sets of PSUs.
